(19) United States
(12) Patent Application Publication
(10) Pub. No.: US 2013/0258708 A1
(43) Pub. Date: Oct. 3, 2013

(54) Backlight Module

(71) Applicant: Jianfa Huang, Shenzhen (CN)

(72) Inventor: Jianfa Huang, Shenzhen (CN)

(73) Assignee: Shenzhen China Str Optoelectronics Technology Co., LTD., Shenzhen City, Guangdong (CN)

(21) Appl. No.: 13/520,567

(22) PCT Filed: Apr. 13, 2012
(86) PCT No.: PCT/CN12/73964

§ 371 Date: Jul. 4, 2012

(30) Foreign Application Priority Data
Apr. 1, 2012 (CN) 201210096092.9

(51) Int. Cl. G09F 13/04

(52) U.S. Cl. 362/608

(57) ABSTRACT

The present invention provides a backlight module including a backplane, a backlight source arranged inside the backplane, and a prism mounted to the backplane and located above the backlight source, and a light guide plate arranged in the backplane. The light guide plate has a light incident surface. The backlight source is located beside the light incident surface of the light guide plate. The backlight source has a light emitting surface, whereby light emitting from the light emitting surface is refracted by the prism to transmit through the light incident surface into the light guide plate in order to have a majority of the light emitting from the backlight source deflected to directly enter the light guide plate, thereby reducing loss of optic energy and improving light coupling efficiency.

### BACKGROUND OF THE INVENTION

1. Field of the Invention

The present invention relates to the field of liquid crystal displaying, and in particular to a backlight module that enhances high coupling efficiency.

2. The Related Arts

Liquid crystal display (LCD) has a variety of advantages, such as compact device size, low power consumption, and being free of radiation, and is thus widely used. Most of the LCDs that are currently available in the market are backlighting LCDs, which comprise a liquid crystal panel and a backlight module. The working principle of the liquid crystal panel is that liquid crystal molecules are interposed between two parallel glass substrates and a plurality of vertical and horizontal fine electrical wires is arranged between the two glass substrates, whereby the liquid crystal molecules are controlled to change direction by application of electricity in order to refract light emitting from the backlight module for generating images. Since the liquid crystal panel itself does not emit light, light must be provided by the backlight module in order to normally display images. Thus, the backlight module is one of the key components of an LCD. The backlight module can be classified as two types, namely side-edge backlight module and direct backlight module, according to the position where light gets incident. The direct backlight module arranges a light source, such as a cold cathode fluorescent lamp (CCFL) or a light-emitting diode (LED) at the back side of the liquid crystal panel to form a planar light source that directly provides lighting to the liquid crystal panel. The side-edge backlight module arranges a backlight source, such as an LED light bar based light source, at an edge of a back panel that is located rearward of one side of the liquid crystal panel. The LED light bar emits light that enters a light guide plate through a light incident face of the light guide plate and is projected out through a light exit face after being reflected and diffused to thereby form, after transmitting through a set of optic films, a planar light source to be provided to the liquid crystal panel.

As shown in FIG. 1, a conventional bottom-emission side-edge backlight module comprises a backplane 1, a heat dissipation plate 2 disposed on the backplane 1, a backlight source 3 disposed on the heat dissipation plate 2, a middle frame 4 arranged on the backplane, and a side reflector plate 5 mounted to the middle frame 4, a light guide plate 6 arranged above the backplane 1, a bottom reflector plate 7 mounted under the light guide plate 6, and an optic film assembly 8 disposed on the light guide plate 6. A backlighting chamber is formed among the backlight source 3, the side reflector plate 5, and the light guide plate 6. The backlight source 3 has a light exit surface that faces upward vertically so that light emitting from the backlight source 3 is reflected by the side reflector plate 5 into the light guide plate 6. Such an arrangement of backlight module is advantageous for slim bezel design and a bezel that is as slim as 4.3 mm can be realized.

However, such a bottom-emission side-edge backlight module makes most of the light reflected by the reflector plate of the backlighting chamber first before entering the light guide plate. In such a process, a fraction of the light is reflected or refracted in a direction toward the backlight source and is thus absorbed by the packaging of the backlight source, thereby lowering the coupling efficiency of light. Further, the known structure of bottom-emission side-edge backlight module the shape and location of the side reflector plate must be optimized in order to enhance light coupling. This is disadvantageous to bezel slimming and size thinning.

### SUMMARY OF THE INVENTION

Thus, an object of the present invention is to provide a backlight module that has high light coupling efficiency and facilitates bezel slimming.

To achieve the object, the present invention provides a backlight module, comprising a backplane, a backlight source arranged inside the backplane, and a prism mounted to the backplane and located above the backlight source, and a light guide plate arranged in the backplane. The light guide plate has a light incident surface. The backlight source is located beside the light incident surface of the light guide plate. The backlight source has a light emitting surface, whereby light emitting from the light emitting surface is refracted by the prism to transmit through the light incident surface into the light guide plate.

The prism is a triangular prism, which has a bottom face confronting the light incident surface of the light guide plate, a first side face confronting the backlight source, and a second side face connecting between the bottom face and the first side face.

The bottom face of the triangular prism is substantially parallel to the light incident surface and the bottom face is spaced from the light incident surface by a distance less than 1 mm. The first side face is substantially parallel to the light emitting surface of the backlight source, and the first side face is spaced from the light emitting surface by a distance of 0.1-2 mm.

The first side face forms an angle with respect to the light emitting surface.

The prism is a composite prism composed of a plurality of triangular prisms. The triangular prisms are sequentially stacked and each of the triangular prisms comprises a bottom face confronting the light incident surface of the light guide plate, a first side face confronting the backlight source, and a second side face connecting between the bottom face and the first side face, whereby light emitting from the light emitting surface of the backlight source is refracted, in sequence, by the first side faces and the second side faces of the triangular prisms to transmit through the light incident surface and get into the light guide plate.

The bottom faces of the triangular prisms are located on the same plane and are substantially parallel to the light incident surface of the light guide plate and are spaced from the light incident surface by a distance less than 1 mm. The first side faces of the triangular prisms are substantially parallel to the light emitting surface of the backlight source, and the first side face of the lowermost the triangular prism of the composite prism is spaced from the light emitting surface by a distance of 0.1-2 mm.

The prism is made as a unitary member through injection molding.

The prism is made of quartz glass, polymethyl methacrylate (PMMA), or polycarbonate (PC).

The prism is located exactly above the backlight source.

The backlight module further comprises a middle frame mounted to the backplane, a side reflector plate mounted inside the middle frame, a bottom reflector plate arranged between the light guide plate and the backplane, a heat dissipation plate arranged between the backplane and the backlight source, and an optic film assembly disposed on the light guide plate. The side reflector plate is located beside the light incident surface of the light guide plate. The backlight source is located between the side reflector plate and the light incident surface of the light guide plate.

The efficacy of the present invention is that the present invention provides a backlight module that arranges at least one prism exactly above the backlight source to cause refraction of the incident light in order to have a majority of the light emitting from the backlight source deflected to directly enter the light guide plate, thereby reducing loss of optic energy and improving light coupling efficiency. Further, optimization of the location and shape of the side reflector plate that is desired in the known techniques is no longer necessary so that the thickness of the backlight module is decreased and the bezel width of the light incidence side of the backlight module is reduced, thereby facilitating realizing bezel slimming.

For better understanding of the features and technical contents of the present invention, reference will be made to the following detailed description of the present invention and the attached drawings. However, the drawings are provided for the purposes of reference and illustration and are not intended to impose undue limitations to the present invention.

### BRIEF DESCRIPTION OF THE DRAWINGS

The technical solution, as well as beneficial advantages, will be apparent from the following detailed description of an embodiment of the present invention, with reference to the attached drawings. In the drawings:

FIG. 1 is a schematic view showing the structure of a conventional bottom-emission side-edge backlight module;

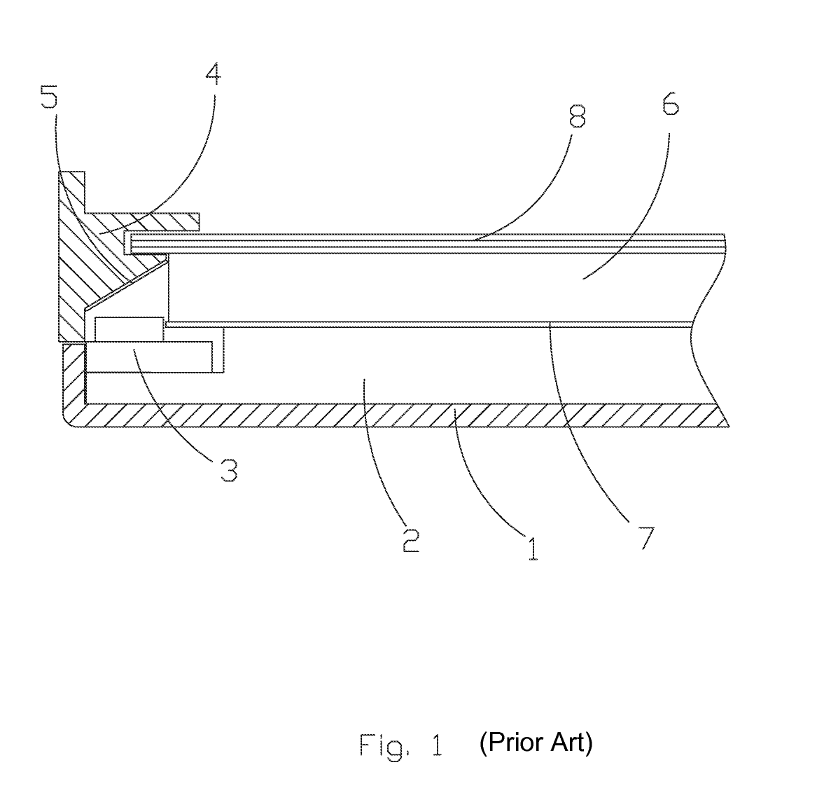

FIG. 2 is a schematic view showing the structure of a backlight module according to the present invention;

FIG. 3 is a perspective view showing a prism of FIG. 2;

FIG. 4 is a schematic view showing optic path of light transmitting through the prism of the present invention;

FIG. 5 is a schematic view showing the structure of a backlight module according to another embodiment of the present invention; and

FIG. 6 is a schematic view showing the structure of a backlight module according to a further embodiment of the present invention.

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

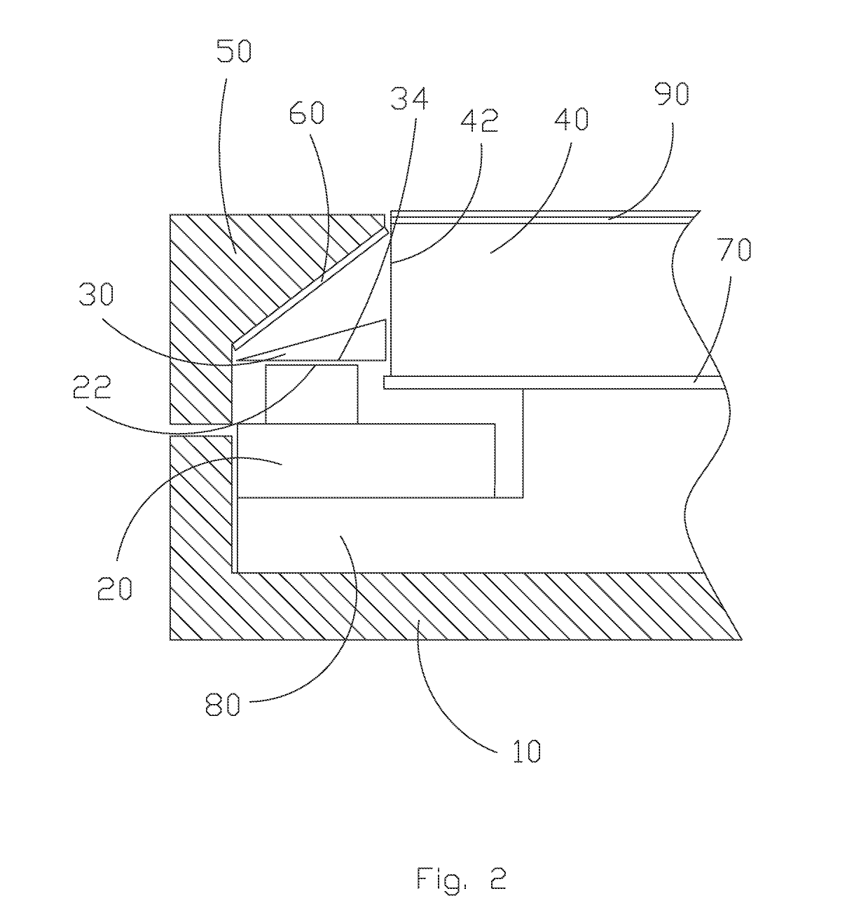

Referring to FIGS. 2-4, the present invention provides a backlight module, which comprises a backplane 10, a backlight source 20 arranged inside the backplane 10, and a prism 30 mounted to the backplane 10 and located above the backlight source 20, and a light guide plate 40 arranged in the backplane 10. The prism 30 is located exactly above the backlight source 20. The light guide plate 40 has a light incident surface 42, and the backlight source 20 is located beside the light incident surface 42 of the light guide plate 40. The backlight source 20 has a light emitting surface 22, and light emitting from the light emitting surface 22 is refracted by the prism 40 to transmit through the light incident surface 42 into the light guide plate 40. This arrangement avoids loss of optic energy caused by light being repeatedly reflected for multiple times before entering the light guide plate 40 in the known techniques and thus improves the light coupling efficiency of the backlight module.

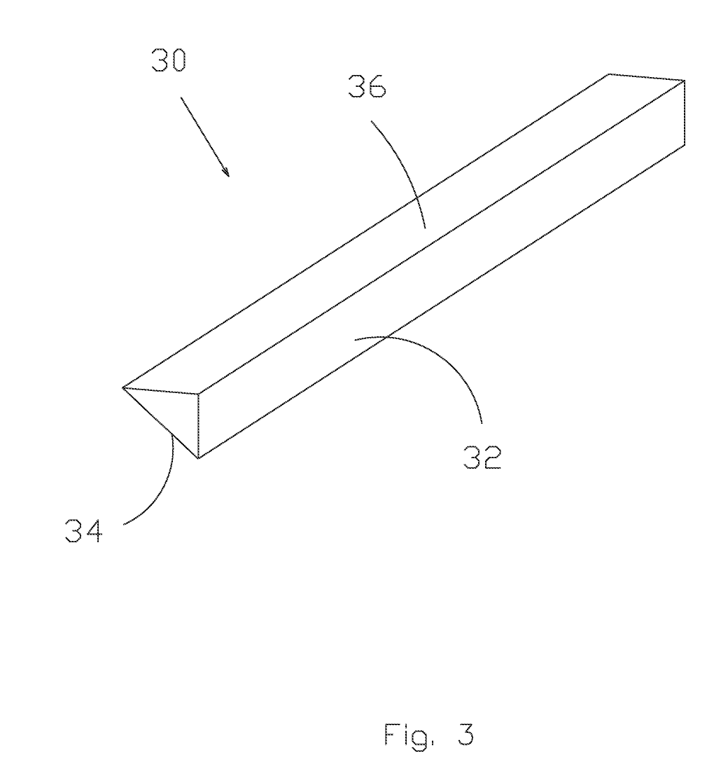

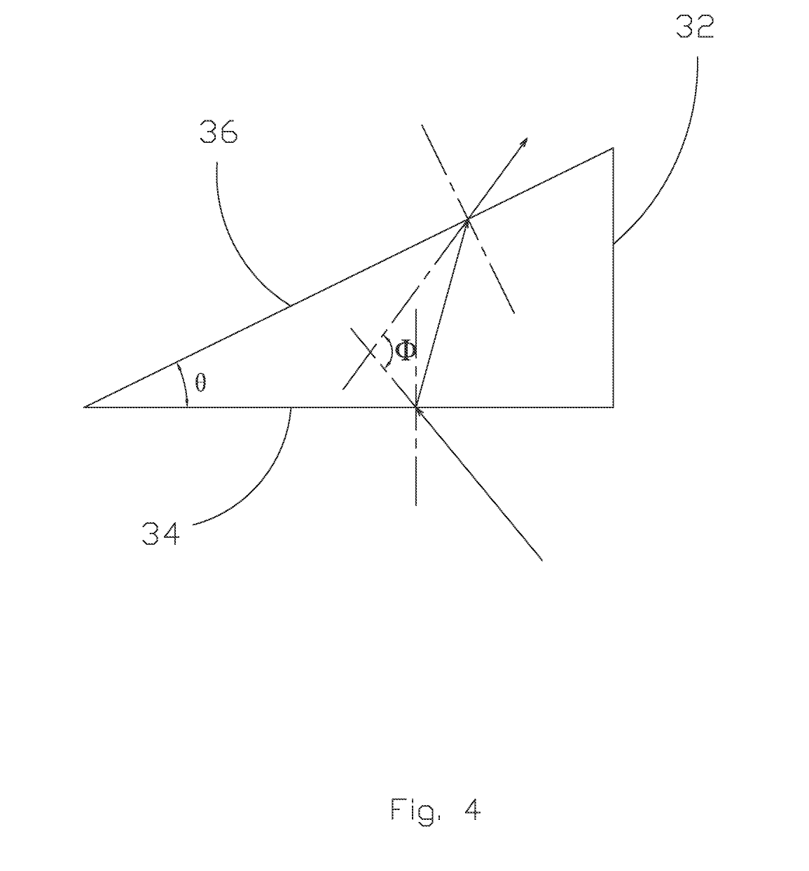

Referring to FIGS. 3 and 4, the prism 30 is a triangular prism, which has a bottom face 32 confronting the light incident surface 42 of the light guide plate 40, a first side face 34 confronting the backlight source 20, and a second side face 36 connecting between the bottom face 32 and the first side face 34. The first side face 34 and the second side face 36 form therebetween an include angle θ. Light that emits from the light emitting surface 22 of the backlight source 20 and is incident to and refracted by the first side face 34 to enter the prism 30 and is refracted by the second side face 36 to leave in such a direction that forms a deflection angle φ with respect to the incident light. For a prism 30 having a refractive index n, the angles θ and φ show the relationship: φ=arc sin (n sin (θ−arc sin (sin (θ/2)/n)))−(θ/2).

It is implied that the maximum of the angle φ can be obtained from the following relationship: φ=2arc sin (n sin (θ/2))−θ. Apparently, the deflection angle φ is determined by the included angle θ between the first and second side faces 34, 36 of the prism 30 and the refractive index n of the prism.

Referring to FIGS. 2 and 3, in a preferred embodiment of the present invention, the prism 30 is a right triangular prism. The bottom face 32 of triangular prism is arranged to be substantially parallel to the light incident surface 42 of the light guide plate 40 and the bottom face 32 is spaced from the light incident surface 42 by a distance less than 1 mm. The first side face 34 is arranged to be substantially parallel to the light emitting surface 22 of the backlight source 20 and the first side face 34 is spaced from the light emitting surface 22 of the backlight source 20 by a distance of 0.1-2 mm.

In the instant embodiment, the light emitting from the light emitting surface 22 of the backlight source 20 is substantially perpendicular to the first side face 34 of the prism 30 and thus no refraction occurs. The light is only refracted at the second side face 36 and then directly transmits through the light incident surface 42 of the light guide plate 40 to enter the light guide plate 40. This allows a majority of the light that emits from the backlight source 20 to be directly enter the light guide plate 40 after being refracted by the prism 30 so as to avoid loss of optic energy caused by light being repeatedly reflected for multiple times before entering the light guide plate 40 in the known techniques and thus improve the light coupling efficiency of the backlight module.

In the instant embodiment, the prism 30 is made of quartz glass, polymethyl methacrylate (PMMA), or polycarbonate (PC).

The backlight module further comprises a middle frame 50 mounted to the backplane 10, a side reflector plate 60 mounted inside the middle frame 50, a bottom reflector plate 70 arranged between the light guide plate 40 and the backplane 10, a heat dissipation plate 80 arranged between the backplane 10 and the backlight source 20, and an optic film assembly 90 disposed on the light guide plate 40. The side reflector plate 60 is located beside the light incident surface 42 of the light guide plate 40. The backlight source 20 is located between the side reflector plate 60 and the light incident surface 42 of the light guide plate 40.

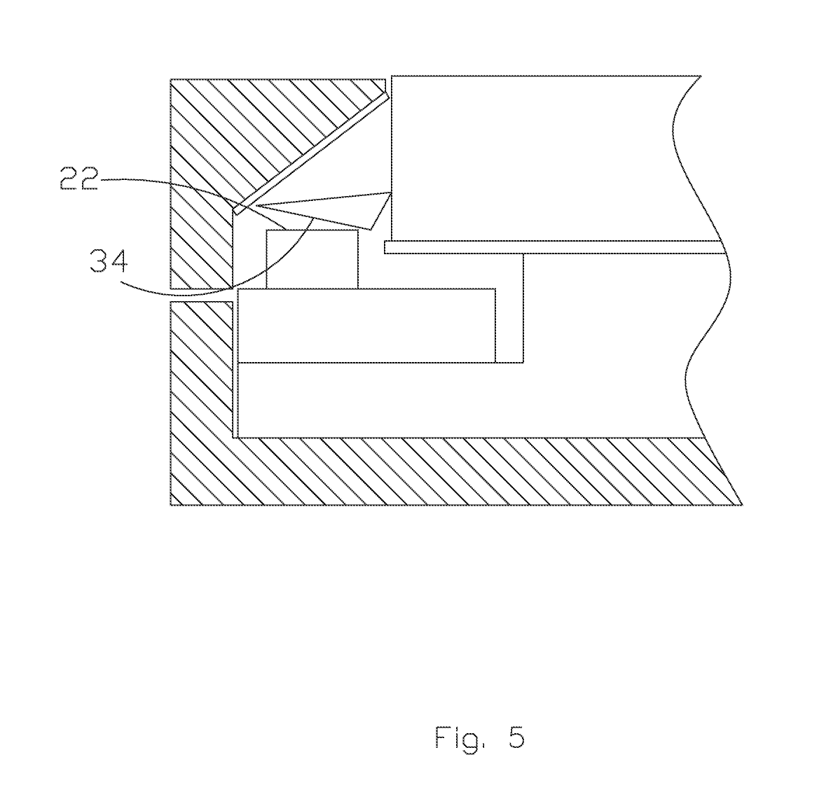

Referring to FIG. 5, which is a schematic view showing the structure of backlight module according to another embodiment of the present invention, in the instant embodiment, an angle is set between the first side face 34 and the light emitting surface 22 in order to realize deflection of greater angle of the refracted light for further reducing loss of optic energy and improving light coupling efficiency of the backlight module.

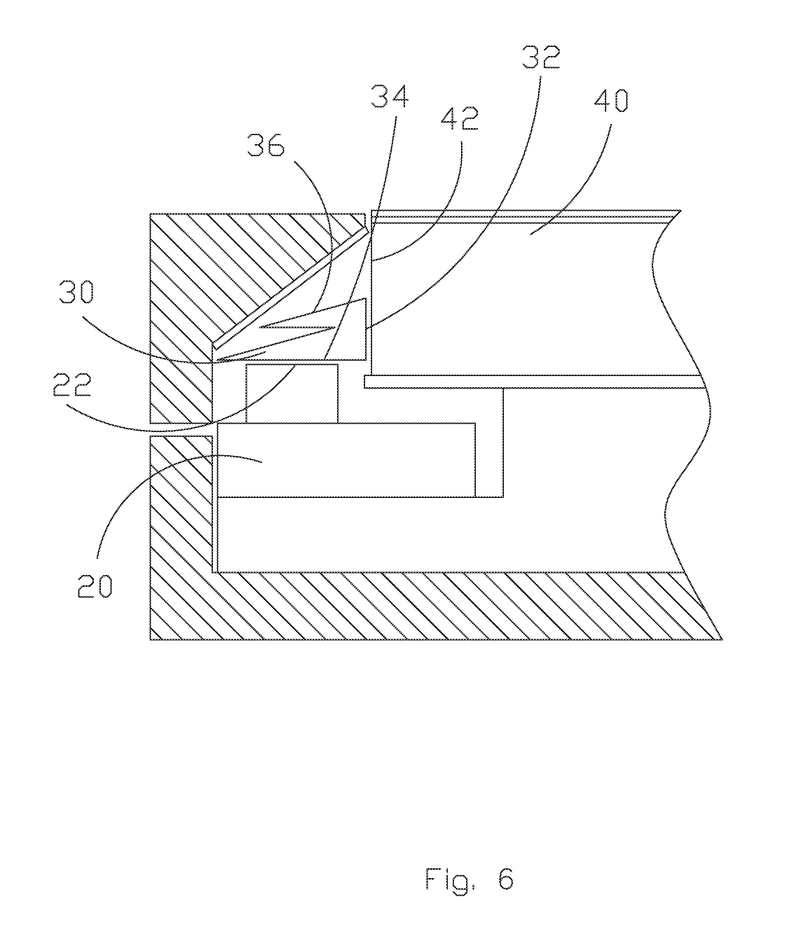

Referring to FIG. 6, which is a schematic view showing the structure of backlight module according to a further embodiment of the present invention, in the instant embodiment, the prism 30 is a composite prism composed of a plurality of triangular prisms. Those triangular prisms are sequentially stacked and each of the triangular prisms comprises a bottom face 32 confronting the light incident surface 42 of the light guide plate 40, a first side face 34 confronting the backlight source 20, and a second side face 36 connecting between the bottom face 32 and the first side face 34. Light emitting from the light emitting surface 22 of the backlight source 20 is refracted, in sequence, by the first side faces 34 and the second side faces 36 of those triangular prisms to transmit through the light incident surface 42 and get into the light guide plate 40.

The bottom faces 32 of the triangular prisms are located on the same plane and are substantially parallel to the light incident surface 42 of the light guide plate 40 and are spaced from the light incident surface 42 by a distance less than 1 mm. The first side faces 34 of the triangular prisms are substantially parallel to the light emitting surface 22 of the backlight source 20 and the first side face 34 of the lowermost the triangular prism of the composite prism is spaced from the light emitting surface 22 by a distance of 0.1-2 mm.

The composite prism can be formed by jointing a plurality of triangular prisms or can be formed through machining. In the instant embodiment, the prism is made as a unitary member through injection molding. In the instant embodiment, since the prism is formed by stacking two or more than two triangular prisms, the incident light can be subjected to deflection of great angle so that a greater amount of light can be directly deflected toward the light guide plate to thereby further reduce loss of optic energy and improve light coupling efficiency of the backlight module.

In summary, the present invention provides a backlight module that arranges at least one prism exactly above the backlight source to cause refraction of the incident light in order to have a majority of the light emitting from the backlight source deflected to directly enter the light guide plate, thereby reducing loss of optic energy and improving light coupling efficiency. Further, optimization of the location and shape of the side reflector plate that is desired in the known techniques is no longer necessary so that the thickness of the backlight module is decreased and the bezel width of the light incidence side of the backlight module is reduced, thereby facilitating realizing bezel slimming.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A backlight module, comprising a backplane, a backlight source arranged inside the backplane, and a prism mounted to the backplane and located above the backlight source, and a light guide plate arranged in the backplane, the light guide plate having a light incident surface, the backlight source being located beside the light incident surface of the light guide plate, the backlight source having a light emitting surface, whereby light emitting from the light emitting surface is refracted by the prism to transmit through the light incident surface into the light guide plate.

2. The backlight module as claimed in claim 1, wherein the prism is a triangular prism, which has a bottom face confronting the light incident surface of the light guide plate, a first side face confronting the backlight source, and a second side face connecting between the bottom face and the first side face.

3. The backlight module as claimed in claim 2, wherein the bottom face of the triangular prism is substantially parallel to the light incident surface and the bottom face is spaced from the light incident surface by a distance less than 1 mm, the first side face being substantially parallel to the light emitting surface of the backlight source, the first side face being spaced from the light emitting surface by a distance of 0.1-2 mm.

4. The backlight module as claimed in claim 2, wherein the first side face forms an angle with respect to the light emitting surface.

5. The backlight module as claimed in claim 1, wherein the prism is a composite prism composed of a plurality of triangular prisms, the triangular prisms being sequentially stacked, each of the triangular prisms comprising a bottom face confronting the light incident surface of the light guide plate, a first side face confronting the backlight source, and a second side face connecting between the bottom face and the first side face, whereby light emitting from the light emitting surface of the backlight source is refracted, in sequence, by the first side faces and the second side faces of the triangular prisms to transmit through the light incident surface and get into the light guide plate.

6. The backlight module as claimed in claim 5, wherein the bottom faces of the triangular prisms are located on the same plane and are substantially parallel to the light incident surface of the light guide plate and are spaced from the light incident surface by a distance less than 1 mm, the first side faces of the triangular prisms being substantially parallel to the light emitting surface of the backlight source, the first side face of a lowermost the triangular prism of the composite prism being spaced from the light emitting surface by a distance of 0.1-2 mm.

7. The backlight module as claimed in claim 5, wherein the prism is made as a unitary member through injection molding.

8. The backlight module as claimed in claim 1, wherein the prism is made of quartz glass, polymethyl methacrylate (PMMA), or polycarbonate (PC).

9. The backlight module as claimed in claim 1, wherein the prism is located exactly above the backlight source.

10. The backlight module as claimed in claim 1, wherein the backlight module further comprises a middle frame mounted to the backplane, a side reflector plate mounted inside the middle frame, a bottom reflector plate arranged between the light guide plate and the backplane, a heat dissipation plate arranged between the backplane and the backlight source, and an optic film assembly disposed on the light guide plate, the side reflector plate being located beside the light incident surface of the light guide plate, the backlight source being located between the side reflector plate and the light incident surface of the light guide plate.

11. A backlight module, comprising a backplane, a backlight source arranged inside the backplane, and a prism mounted to the backplane and located above the backlight source, and a light guide plate arranged in the backplane, the light guide plate having a light incident surface, the backlight source being located beside the light incident surface of the light guide plate, the backlight source having a light emitting surface, whereby light emitting from the light emitting surface is refracted by the prism to transmit through the light incident surface into the light guide plate;
wherein the prism is a triangular prism, which has a bottom face confronting the light incident surface of the light guide plate, a first side face confronting the backlight source, and a second side face connecting between the bottom face and the first side face;
wherein the bottom face of the triangular prism is substantially parallel to the light incident surface and the bottom face is spaced from the light incident surface by a distance less than 1 mm, the first side face being substantially parallel to the light emitting surface of the backlight source, the first side face being spaced from the light emitting surface by a distance of 0.1-2 mm;
wherein the prism is made of quartz glass, polymethyl methacrylate (PMMA), or polycarbonate (PC);
wherein the prism is located exactly above the backlight source; and
wherein the backlight module further comprises a middle frame mounted to the backplane, a side reflector plate mounted inside the middle frame, a bottom reflector plate arranged between the light guide plate and the backplane, a heat dissipation plate arranged between the backplane and the backlight source, and an optic film assembly disposed on the light guide plate, the side reflector plate being located beside the light incident surface of the light guide plate, the backlight source being located between the side reflector plate and the light incident surface of the light guide plate.
